(19) United States
(12) Patent Application Publication
(10) Pub. No.: US 2013/0312667 A1
(43) Pub. Date: Nov. 28, 2013

(54) Refrigerated Pet Litter Box

(71) Applicant: Carl Fisher, New York, NY (US)

(72) Inventor: Carl Fisher, New York, NY (US)

(21) Appl. No.: 13/875,498

(22) Filed: May 2, 2013

Related U.S. Application Data
(60) Provisional application No. 61/641,989, filed on May 3, 2012.

(51) Int. Cl. A01K 1/01

(52) U.S. Cl. CPC A01K 1/0107
USPC 119/165

(57) ABSTRACT

A refrigerated cat litter box is disclosed that includes a cover having a top wall and one or more sidewalls extending therefrom and a base having a bottom wall and one or more sidewalls extending therefrom. The cover is positioned over the base to form the litter box and a cooling assembly is in communication with the litter box to cool the litter box. The cooling of the litter box delays the growth and reproduction of bacteria to preserve the litter inside of the litter box and to reduce the amount of malodorous air present in the enclosure.

### FIELD OF THE INVENTION

The present invention claims priority on U.S. Provisional Patent Application No. 61/641,989 filed May 3, 2012, the disclosures of which are incorporated herein by reference.

The present invention relates to a refrigerated pet litter box. The inside of the pet litter box is cooled to slow and/or reduce the growth and reproduction of bacteria inside of the litter box. The delayed, or reduced growth reduces odor, creates a more pleasantly smelling enclosure and preserves the pet litter inside of the box, which allows the pet litter to be used for a longer period of time.

### BACKGROUND OF THE INVENTION

A litter box is an indoor waste disposal location that is primarily used for cats but that may also be used for other animals, including rabbits, ferrets, small dogs or other pets that are trained by an owner to use a litter box. Cats are the primary animal that uses a litter box because they instinctively excrete feces and urine in soft or sandy soil for easy burial. As a way to stimulate a cat's instinctive nature, the bottom of a litter box is filled with a layer of litter, which comes in two types—conventional or clumping. Conventional litter is a loose granular material that requires removing the entire content of the litter every time the box is cleaned to ensure a fresh supply of litter for the cat. Clumping litter, on the other hand, contains granules that stick to together when it comes into contact with liquid. An owner cleaning the litter only has to remove the formed clumps of the litter and not the entire amount as required with conventional litter.

As a result of the feces and urine that are present in the litter box, there have been litter boxes developed that contain sanitizing features. These features include heating the litter, shining an ultraviolet light on the litter, controlling the odor produced by the litter with ozone from an ozone generator, and removing the malodorous air with an exhaust fan. The present invention, on the other hand, is directed to a different mechanism for controlling the growth and reproduction of bacteria present in a pet's waste inside of the litter box. In particular, the present invention relates to a refrigerated pet litter box. The cooling of the pet litter box slows the growth and reproduction of the bacteria. This creates a more pleasantly smelling enclosure and also preserves the litter inside of the box. The preservation of the litter allows it to be used for a longer period of time before a change is required.

### OBJECTS OF THE INVENTION

It is an object of the present invention to provide a pet litter box that is cooled to slow the growth and reproduction of bacteria that is present in a pet's waste.

It is another object of the present invention to provide a pet litter box that reduces the amount of malodorous air produced by a pet's waste.

It is a further object of the present invention to provide a pet litter box that preserves the litter in the box and allows the litter to be used for a longer period of time by cooling the inside of the litter box.

### SUMMARY OF THE INVENTION

The present invention relates to a pet litter box that is refrigerated to slow the growth and reproduction of bacteria that is present in a pet's waste, and in particular a cat. The slower growth and reproduction of bacteria leads to a more pleasantly smelling enclosure by reducing the amount of malodorous air present in the litter box enclosure. The delayed growth and reproduction of the bacteria also preserves the litter and allows it to be used for a longer period of time.

The refrigerated cat litter box generally includes a first member that is defined by a base portion that has a bottom wall or surface and one or more sidewalls extending upwards therefrom that define an open area therebetween. The base portion can be used as a receptacle for cat type litter or other absorbent material. If desired, there may also be a cover portion that has a top wall or surface and one or more sidewalls extending downwards therefrom that also define an open area therebetween. The cover generally provides privacy for the pet using the device. The edges of the sidewalls of the base and cover may be flanged to allow the flanged edges of the cover to rest on the flanged edges of the base to form the enclosure of the litter box. There is also one or more openings in one or more of the litter box's sidewalls to allow the cat to enter and exit the litter box. A cooling assembly is further included and is in contact with the litter box and/or the litter to cool the enclosed area defined by the litter box. The cooling assembly comprises a control unit that is in communication with a cooling element. The cooling element is in communication with the litter box to cool the inside of the litter box

### BRIEF DESCRIPTION OF THE DRAWINGS

FIG. 1 shows a perspective view of the components of a first embodiment of the present invention where the control unit of the cooling assembly is secured to the rear wall of the cover.

FIG. 2 shows a perspective view of the litter box of FIG. 1 where the components of the litter box are assembled.

FIG. 3 shows a top view of the litter box of FIG. 2 wherein a section of the cover is cut-out to show the inside of the litter box.

FIG. 4 shows a side view of the litter box of FIG. 2.

FIG. 5 shows a perspective view of the components of an alternate embodiment of the litter box where the control unit of the cooling assembly is secured to the top wall of the cover.

FIG. 6 shows a perspective view of the litter box of FIG. 5 where the components of the litter box are assembled.

FIG. 7 shows a top view of the litter box of FIG. 6.

FIG. 8 shows a side view of the litter box of FIG. 6.

FIG. 9 shows a perspective view of an alternate embodiment of the litter box of FIGS. 1-4 wherein a door is hinged to the entrance of the litter box.

FIG. 10 shows a perspective view of the litter box of FIG. 9 wherein the components of the litter box are assembled.

FIG. 11 shows a side view of the litter box of FIG. 10.

FIG. 12 shows a top view of the litter box of FIG. 10.

FIG. 13 shows a perspective view of an alternate embodiment of the litter box of FIGS. 5-8 wherein a door is hinged to the entrance of the litter box.

FIG. 14 shows a perspective view of the litter box of FIG. 13 wherein the components of the litter box are. assembled.

FIG. 15 shows a top view of the litter box of FIG. 14 wherein a section of the cover is cut-out to show the inside of the litter box.

FIG. 16 shows a side view of the litter box of FIG. 14.

FIG. 17 shows a perspective view of a further alternate embodiment of the present invention that includes the cooling coils resting on top of the control unit and having a contact plate as the interface between the cooling coil and the bottom wall of the base of the litter box.

FIG. 18 shows a perspective view of the litter box of FIG. 17 wherein the components of the litter box and cooling assembly are assembled and wherein the litter box rests on top of the cooling assembly.

FIG. 19 shows a top view of the litter box of FIG. 18.

FIG. 20 shows a side view of the litter box of FIG. 18.

FIG. 21 shows a perspective view of an even further alternate embodiment of the present invention that includes a thermoelectric cooling element in the cooling assembly.

FIG. 22 shows a perspective view of the litter box of FIG. 21 wherein the components of the litter box and cooling assembly are assembled and wherein the litter box rests on top of thermoelectric cooling element.

FIG. 23 shows a top view of the litter box of FIG. 22.

FIG. 24 shows a side view of the litter box of FIG. 22.

FIG. 25 shows a perspective view of an alternate embodiment of the litter box of FIGS. 21-24.

FIG. 26 shows a perspective view of the litter box of FIG. 25 wherein the components of the litter box and cooling assembly are assembled and wherein the litter box rests on top of thermoelectric cooling element.

### DETAILED DESCRIPTION OF THE INVENTION

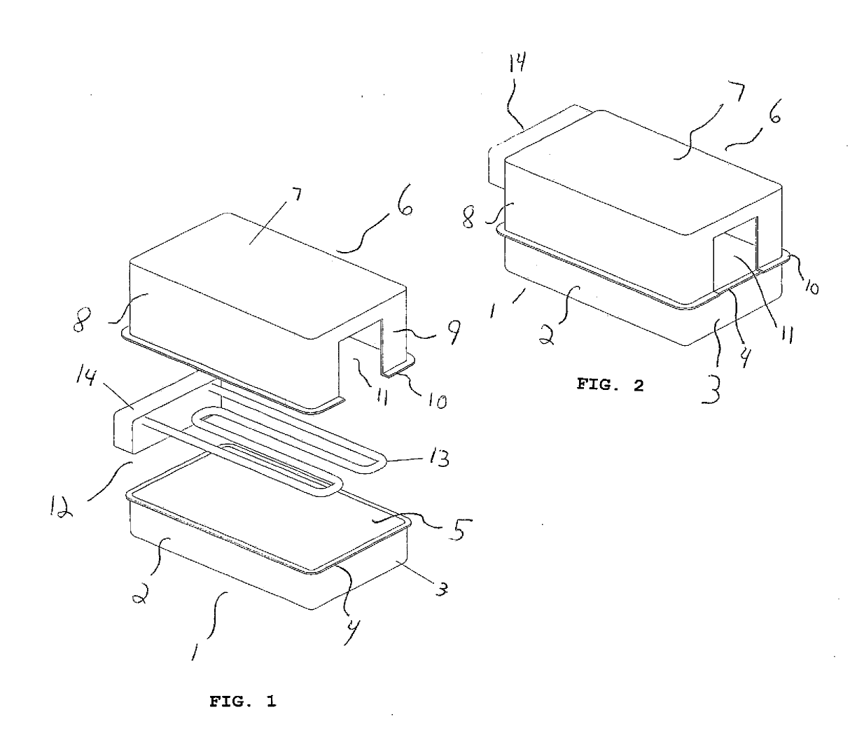

In a first embodiment of the present invention as represented by FIG. 1, the cat litter box includes a base 1 that has a bottom wall or surface (not shown) and a first side 2, second side (not shown), front 3 and rear (not shown) sidewall extending from the respective edges of the bottom wall to a flanged edge 4. The sidewalls combine to define an opening 5 in the base 1. A cover 6 may be placed on top of the base 1 and can comprise a top wall 7 and a first side 8, second side (not shown), front 9, and rear (not shown) sidewall extending from the respective edges of the top wall 7 to a flanged edge 10. The sidewalls of the cover combine to define an open area in the cover. An entranceway for a pet is defined by an opening 11 in the front wall 9 of the cover 6. A cooling assembly 12 is secured in the cover's open area and includes a cooling coil 13 as a cooling element that is connected to a control unit 14. The cooling coil 13 is shown as having three loops but in other embodiments it may have more than or less than three loops and may have a different length and/or width. In addition, the cooling coil lays substantially parallel with the top wall of the cover portion and its three spaced apart loops allow it to substantially cover the length and width of the inside of the litter box. The cooling coil can be on varuous positions in the cat litter box. In one embodiment the coil can be positioned mear the ceiling of the cat litter box. Alternatively, the coil can be embedded in the cat litter either on the surface of the cat litter or under a portion of the cat litter.

One of the issues with pet urine is that the bacteria that grow in its presence can create by products that are corrosive, such as, ammonia and other chemicals that can have a deleterious effect on the coils. It is preferred that the coils be made from a non-corrosive material such as a brass, stainless steel or nickel or titanium or alloys thereof. The stainless steel can be an alloy known as 316. If aluminum is used it should be an anodised aluminum. In another embodiment the coils can be made from a base metal and coated with a corrosive resistant material such as polyethylene, polypropylene, nylon, polyester.

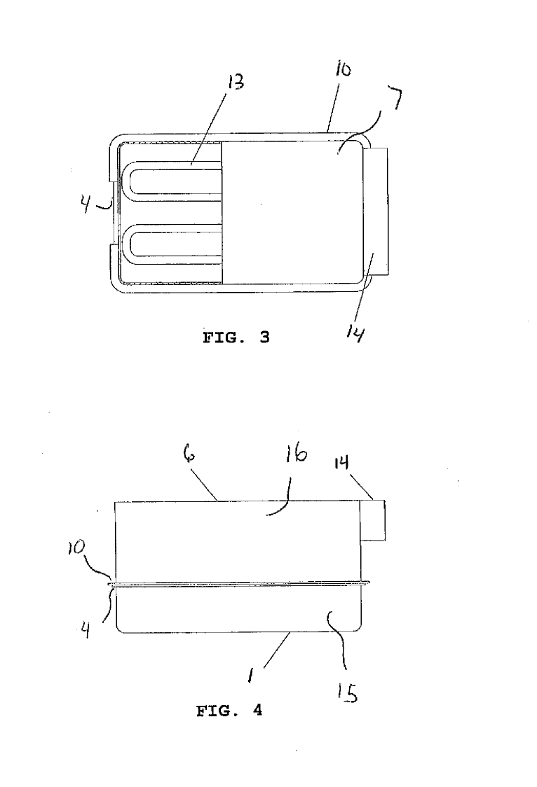

FIG. 2 shows a perspective view of the cat litter box of FIG. 1 where the cover 6 and base 1 are positioned and where the cooling assembly is present and preferably secured in the open area of the cover 6. The control unit 14 of the cooling assembly is shown as being secured to an outside of the rear wall of the cover 6. There may be one or more openings in the rear wall to allow the cooling coil 13 and control unit 14 to be operatively joined. Preferably any open area between the cover and the cooling coil is sealed to prevent cool air from exiting the enclosure from anywhere other than the opening 11 in the front wall 9 of the cover 6. Keeping the control unit 14 outside of the litter box prevents undesirably exhaust or fluids from the cooling unit from entering the litter box. Also shown in FIG. 2 is the flanged edge 10 of the cover 6 resting on the flanged edge of the base 1 to position and preferably secure the cover in place over the base. The flanged edges provide a greater surface area for the sidewalls of the cover 6 to securely rest on the sidewalls of the base 1. Other arrangements are possible for supporting the cover.

The cover preferably rests on the base without any additional securing means. The force exerted by the weight of the cover and/or friction between the two maintains the cover in its position. Additional securing means may be used in alternate embodiments, however, and include but are not limited to clips over the flanged edges, snap locks between the flanged edges, or pins etc. that may be inserted through aligned openings in the flanged edges wherein the pins have protrusions on their upper and lower portion of which one or both may be retractable to prevent the pins from leaving the openings.

With reference to FIG. 3, shown is a top view of the cat litter box with a cut away view of a portion of the cover that is resting on top of the base. The cooling coils 13 are shown in the cut away portion of the cover 6 as well as the coil's cooling unit 14 that is secured to the rear wall of the cover 6.

The cooling coil and control unit represent a closed system of fluid. The fluid is cooled by the control unit and then directed through the cooling coil where the fluid in the coil absorbs heat from inside of the litter box to cool the enclosure. The warmed fluid then returns to the control unit where it is cooled and then directed through the coil again. The cooling system is similar to the type used for refrigerators and/or air conditioning systems which are known to one skilled in the relevant art.

Turning now to FIG. 4, a side view of the cat litter box of FIG. 1 is shown with the cover 6 resting on the base 1. Also shown is the second sidewall of the base and cover 15 and 16 respectively and the flanged edges of the cover and base 4 and 10.

The control unit may be permanently or removably affixed to the rear wall of the cover. Removable attaching means include snap locks, hooks, Velcro hook and loop fastening strips, etc. Non-removable attaching means include a strong adhesive, one or more screws, etc.

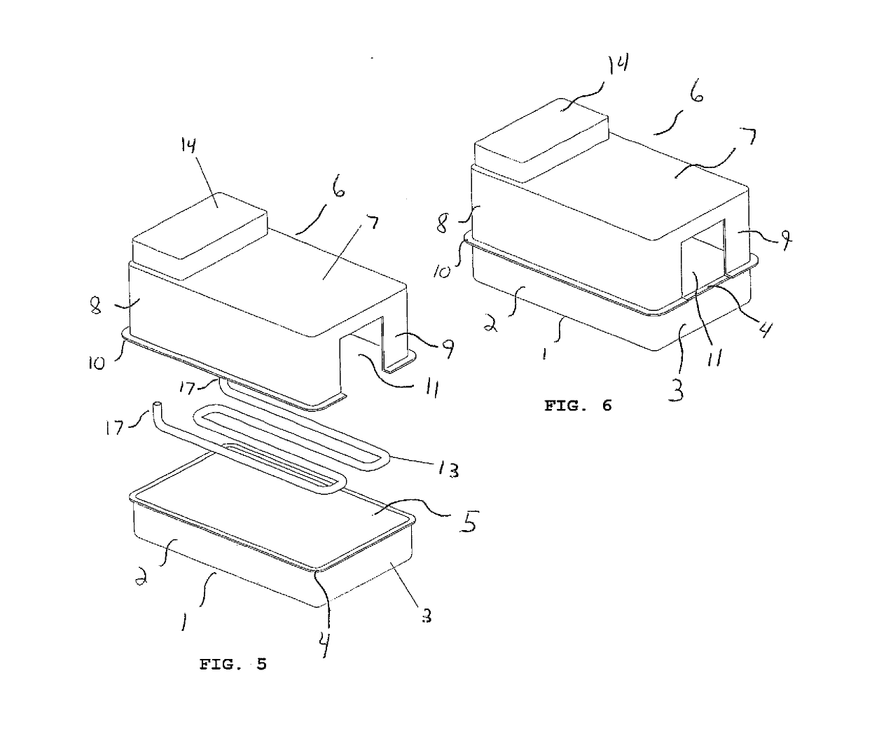

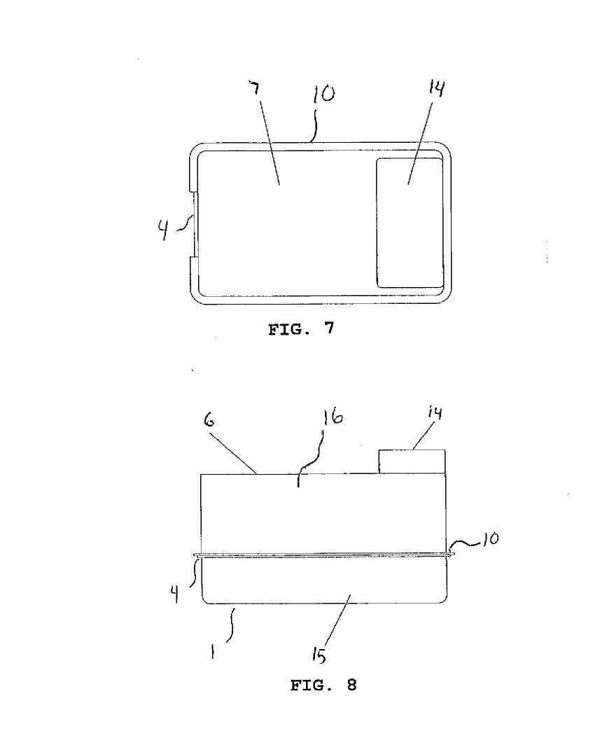

FIGS. 5-8 show a second embodiment of the invention where the cooling assembly is positioned differently. In this embodiment, the control unit 14 resides on and is secured to the exterior surface of the cover's top wall 7. The cooling coil 13 is positioned inside the litter box in the open area that is defined by the cover. The coil also has two ends 17 that are curled or curved to a substantially 90° angle so that the coil can connect to the control unit that is positioned on the exterior surface of the cover's top wall 7. There may be one or more openings (not shown) in the top wall to allow the cooling coil 13 to remain in fluid communication with the control unit 14.

The control unit may be permanently or removably affixed to the top wall of the cover. Removable attaching means include snap locks, Velcro hook and loop fastening strips, etc. Non-removable attaching means include a strong adhesive, one or more screws, etc.

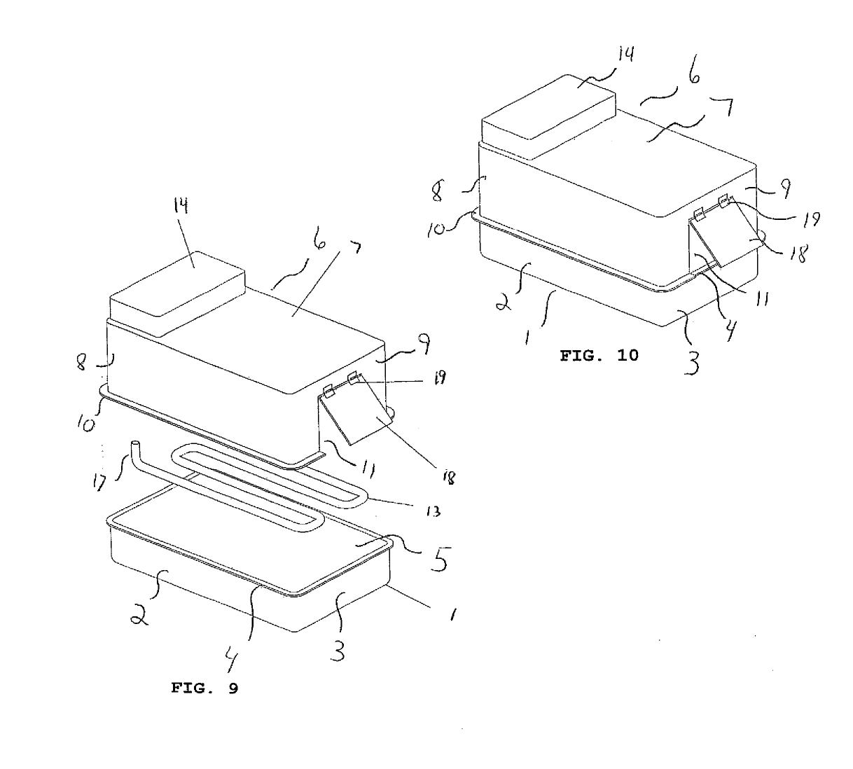

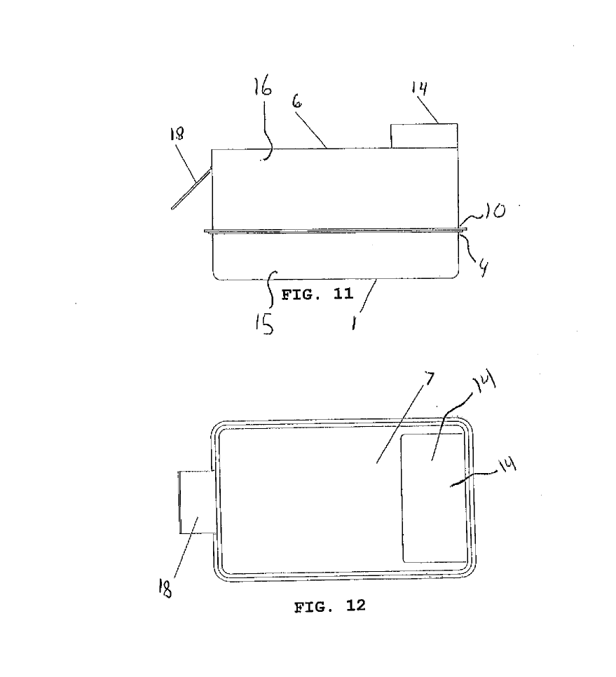

A third embodiment of the present invention is illustrated in FIGS. 9-12. This embodiment is the same as the embodiment shown in FIGS. 5-8 except that a flap 18 is hinged 19 to the opening in the cover's front wall. The flap functions as a door for a cat to enter and exit the litter box and provides privacy.

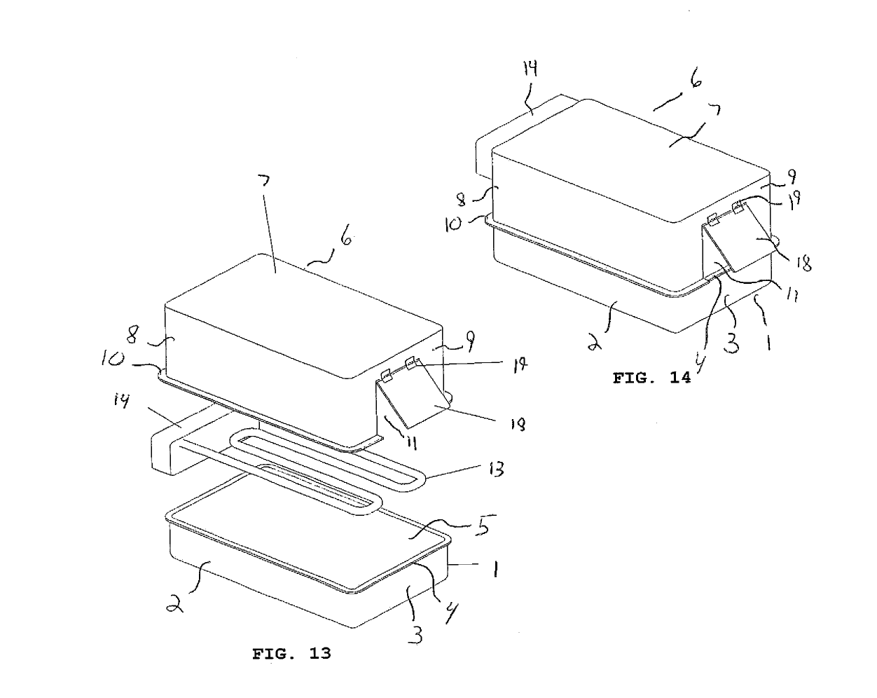

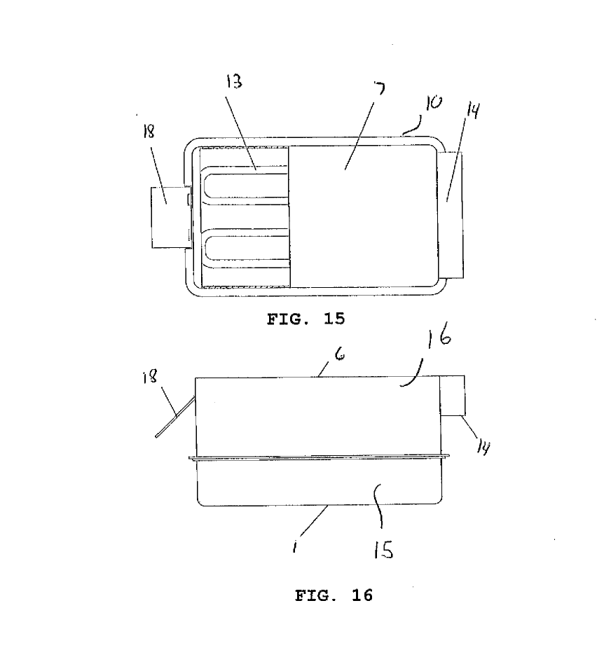

A fourth embodiment of the invention is illustrated in FIGS. 13-16. The fourth embodiment is the same as the embodiment depicted in FIGS. 1-4. The only difference is the addition of a hinged flap to the opening of the cover's front wall. As in the third embodiment, the flap serves as a door to the litter box. It will be appreciated that other door arrangements are possible.

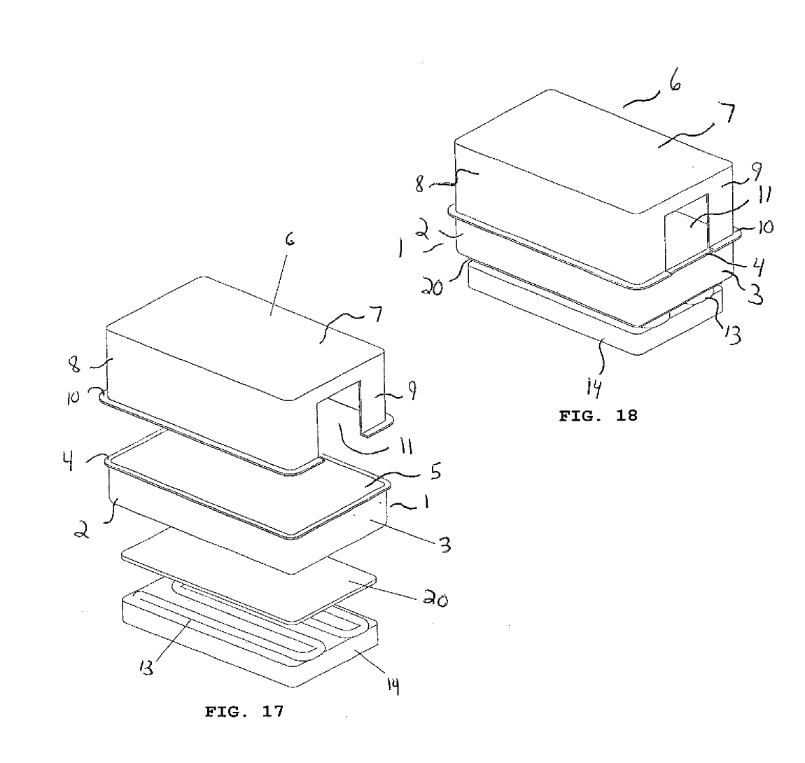

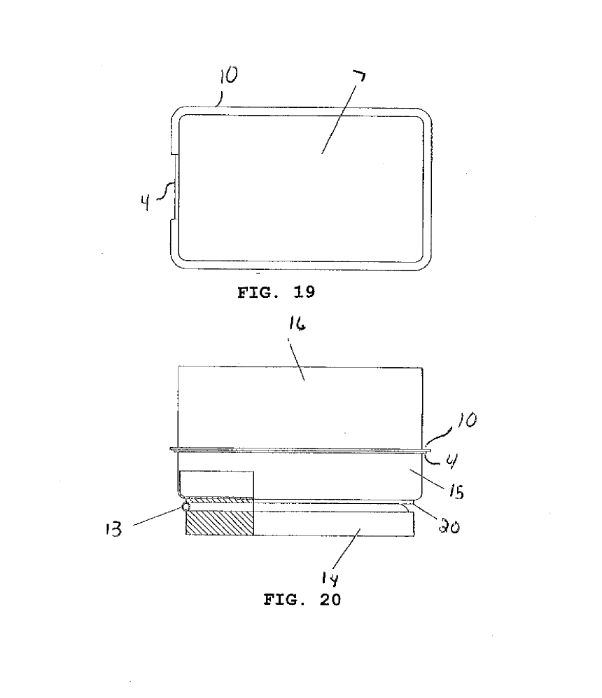

FIGS. 17-20 present a fifth embodiment of the refrigerated cat litter box of the present invention. In this embodiment the base 1 of the litter box rests on top of the cooling assembly 12. The cooling assembly 12 in this embodiment includes the cooling coil 13 resting on top of the control unit 14. The assembly further includes a contact plate 20 as the interface between the cooling coil 13 and the bottom wall of the base of the litter box. FIG. 18 shows the assembled litter box resting on the cooling assembly 12. The interface may be a thin layer of plastic, a mesh or screen with openings sized to prevent cat litter or other substrate from falling through the openings. The interface layer may be rigid or flexible.

In the foregoing embodiments, the control unit of the cooling assembly includes a power source for powering the control unit. The power source allows the control unit to cool the fluid in the cooling assembly and to circulate the fluid throughout the cooling assembly. The power source may be a rechargeable or non-rechargeable battery or a conventional electrical plug so the device can be run off of household or other current. Alternatively, other power sources known in the art may also be used including but not limited to a layer of photovoltaic cells in communication with the control unit.

The tubes of the cooling coil are hollow therethrough so that a fluid from the control unit can be received. The cross section of the coil can be round or thin and flat or other suitable shape. If the coil is longer or larger the increased surface area can reduce cooling time. Other shapes for the tubes are possible. In addition, the coil is preferably configured, as illustrated in the foregoing Figures, to cover a broad surface area so that a large area of the litter box is cooled. However other differently coiled configurations are possible.

In addition, in the foregoing embodiments, the fluid in the cooling assembly is preferably a refrigerant but may be any other type of fluid that is used in the relevant art as a cooling agent to cool an area. Moreover, the litter box is preferably constructed of materials that have an insulative property to retain the cool air within the enclosure defined by the litter box. The materials include but are not limited to a hard plastic, a foam material, or a litter box that has an interior and exterior shell of a hard plastic with a layer of insulating foam therebetween.

In one example of the foregoing embodiments, the control unit includes a compressor to reduce the volume of the cooling agent and thereby increase its temperature. The compressed cooling agent is directed through one or more valves that pass an exhaust fan to remove heat from the system and cool the cooling agent. The cooling agent then flows through an expansion valve to reduce its pressure and decrease its temperature. The resulting cooling agent now flows through the litter box where it absorbs heat from the enclosure to cool the enclosure. After the cooling agent has passed through the coils in the litter box, it is returned to the compressor to reduce its volume, increase its temperature, and continue the cooling cycle. This example follows the properties taught by the well known ideal gas law (PV=nRT) which teaches that the pressure and temperature of a gas are directly proportional.

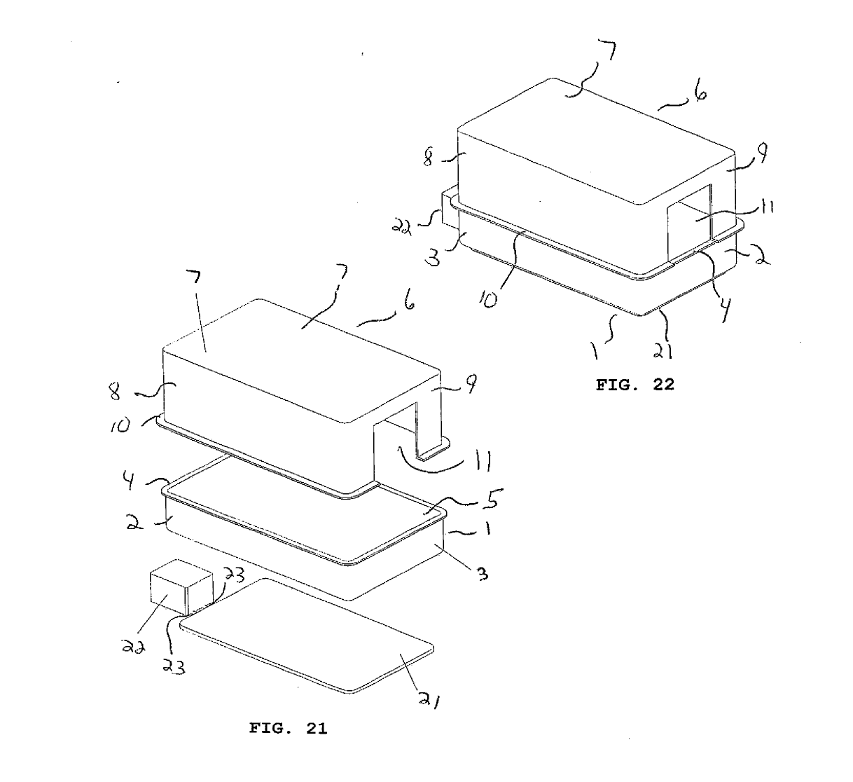

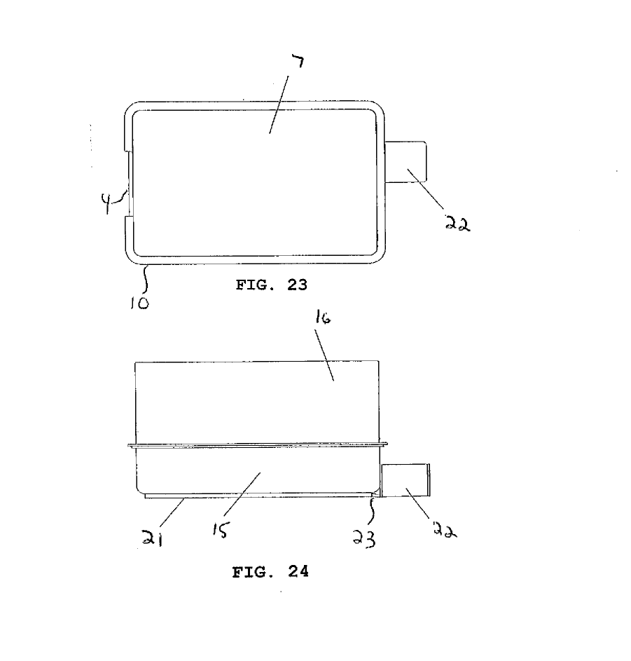

FIGS. 21-24 are illustrations of a sixth embodiment of the present invention. Illustrated in this embodiment is a different cooling assembly than the cooling assembly of the previous embodiments. Rather than cooling coils as the cooling element, the cooling assembly in FIGS. 21-24 comprises a thermoelectric cooling element 21 that is coupled to a control unit 22. The cooling element 21 is coupled to the control unit 22 by conduits 23 that deliver positive and negative charges from the control unit to the cooling element 21. The assembled litter box rests on the thermoelectric cooling element as seen in FIGS. 22 and 24.

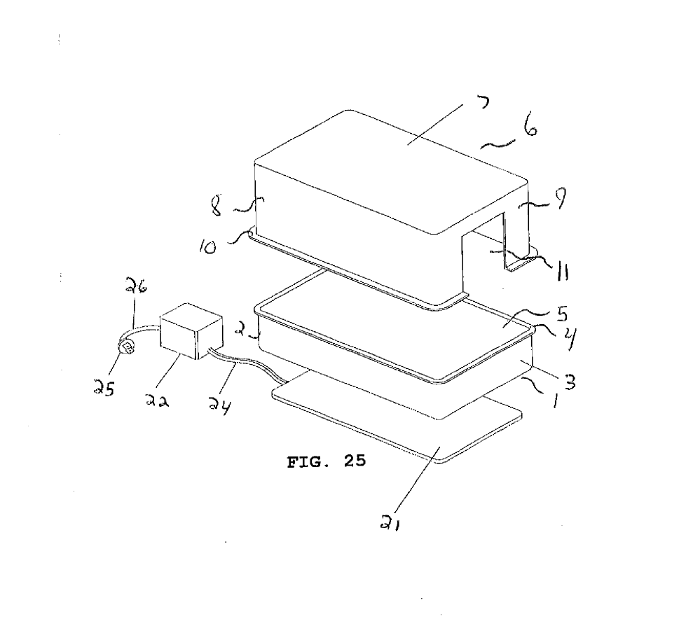

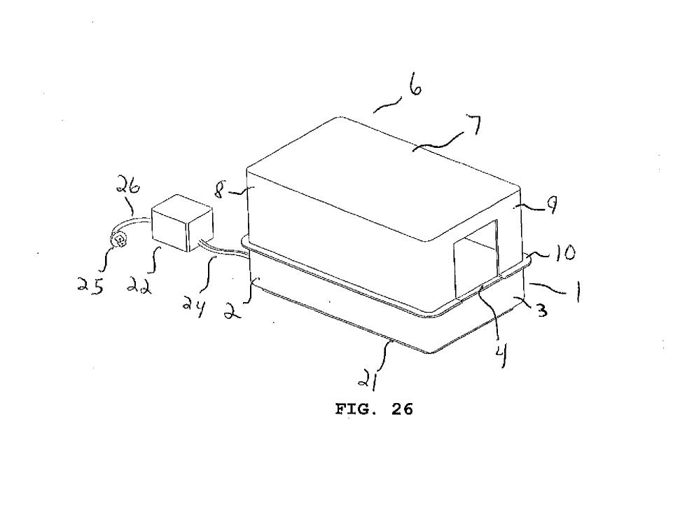

FIGS. 25-26 show an alternate embodiment of the refrigerated cat litter box that is depicted in FIGS. 21-24. Like FIGS. 21-24, the litter box of FIGS. 25-26 has a cooling assembly that includes a thermoelectric cooling element. Unlike FIGS. 21-24, however, the negative and positive charge conduits are housed within a flexible wire 24 connecting the thermoelectric cooling element 21 to the control unit 22. A power source in the form of a plug 25 is attached to the control unit 22 by a flexible wire 26.

The thermoelectric cooling element shown in FIGS. 21-26 is in contact with the bottom wall of the litter box's base so that the bottom wall can receive the cool temperature produced by the thermoelectric cooling element to cool the inside of the litter box and the litter that is stored in the base of the litter box. The cooling element assumes the shape of a pad that has substantially the same length and width of the base's bottom wall. These dimensions provide the cooling element with a maximum amount of surface area to transfer the cool temperature produced by the cooling element to the entire surface of the base's bottom wall. In other embodiments, however, the thermoelectric cooling element may be a different shape or it may be wider and/or longer and thicker and/or thinner than the cooling element shown in FIGS. 21-26. In one embodiment the cooling device may include one or more thermoelectric cooling elements such as Pettier-type thermoelectric elements. Although FIGS. 21-26 show the thermoelectric cooling element on the underside of the base, the thermoelectric cooling element may be inside the litter box system underneath the litter and adjacent to the base or further away from the base in the litter. In this embodiment the litter box system may include a power supply, a processing unit operatively coupled to the cooling device. The processing unit operatively coupled to the cooling device. The processing unit can monitor the temperature via sensors to effectuate the cooling of the interior of the litter box.

The thermoelectric cooling element may comprise a layer of a semiconductor material that is sandwiched between two plates. One of the plates acts as a heat sink. The other layer is made of a conductive material. The thermoelectric cooling element has a cool side and a hot side. The cool side of the element should be in contact with the litter. The size of the cooling element can vary and there can be more than one element used.

The cooling assembly of the foregoing embodiments may also include a thermostat to regulate the temperature inside of the litter box. The thermostat and means for controlling the thermostat may be of any type that is used in the relevant art. In addition, the cooling coil and the thermoelectric cooling element may be placed in any other position around or inside of the litter box as long as the cooling coil and thermoelectric cooling element is in communication with the litter box.

I claim:

1. An improved litter box comprising
a base member having a base wall having an inner surface and an outer surface and one or more sidewalls extending therefrom that define an open area for receiving a pet litter material,
a cover member having a top wall having an inner surface and an outer surface and one or more sidewalls extending downwardly therefrom,
said cover member having an open area for entrance and egress of a pet,
said cover member being adapted to be positioned over said base member to form said litter box,
said litter box having a refrigeration unit secured to an outer surface thereof, said litter box having one or more openings therein receiving a coil extending from the refrigeration unit, said coil passing from the refrigeration unit though said opening into said cat litter box, said coil transporting refrigerated fluid from said refrigeration unit to the litter box to reduce the temperature in said litter box thereby reducing bacterial activity in said pet litter material to decrease the odor of urine and feces in said litter box

2. The litter box according to claim 1 wherein said coils are made from stainless steel anodized aluminum, titanium, nickel and alloys of titanium and nickel

3. The litter box accordingly to claim 1 wherein said coils are made from metal coated with polyethylene, polypropylene, polyester nylon and blends thereof

4. The litter box according to claim 1 wherein said refrigeration unit is secured to the cover of said litter box

5. The litter box according to claim 1 wherein said refrigeration unit is secured to said base of said litter box

6. An improved litter box comprising
a base member having a base wall having an inner surface and an outer surface and one or more sidewalls extending therefrom that define an open area for receiving a pet litter material,
a cover member having a top wall having an inner surface and an outer surface and one or more sidewalls extending downwardly therefrom,
said cover member having an open area for entrance and egress of a pet,
said cover member being adapted to be positioned over said base member to form said litter box,
said litter box having a thermoelectric cooling element in said base and adapted to contact said litter material, said litter box having one or more openings therein receiving wires to provide an electrical connection to said thermoelectric cooling element, said
thermoelectric cooling element reducing the temperature in said litter box thereby reducing bacterial activity in said pet litter material to decrease the odor of urine and feces in said litter box.

7. The litter box according to claim 6 wherein there is a processing unit and one or more sensors for regulating the temperature in the litter box

8. The litter box according to claim 7 wherein said thermoelectric cooling element is positioned adjacent the inner surface of the base wall,

9. The litter box according to claim 8 wherein there is a barrier layer between said thermoelectric cooling element and said litter to prevent urine from contacting said thermoelectric cooling element.

10. The litter box according to claim 8 wherein the thermoelectric cooling element has a protective coating of a non-corrosive material to prevent urine from contacting said thermoelectric cooling element.
